(19) United States
(12) Patent Application Publication
(10) Pub. No.: US 2019/0348008 A1
(43) Pub. Date: Nov. 14, 2019

(54) TOUCH-PANEL-EQUIPPED DISPLAY DEVICE

(71) Applicant: SHARP KABUSHIKI KAISHA, Sakai City, Osaka (JP)

(72) Inventors: MASAKATSU TOMINAGA, Sakai City (JP); YOSHIHITO HARA, Sakai City (JP); MASAHIRO YOSHIDA, Sakai City (JP)

(21) Appl. No.: 16/327,590

(22) PCT Filed: Aug. 21, 2017
(86) PCT No.: PCT/JP2017/029732

§ 371 Date: May 29, 2019

(30) Foreign Application Priority Data
Aug. 22, 2016 (JP) 2016-162037

(51) Int. Cl. G09G 3/36; G02F 1/1362; G02F 1/1333; G06F 3/041

(52) U.S. Cl. CPC G09G 3/3688; G02F 1/136286; G09G 3/3677; G06F 3/041; G02F 1/1333

(57) ABSTRACT

Provided is a touch-panel-equipped display device in which touch detection sensitivity can be improved. A touch-panel-equipped display device 10 includes an active matrix substrate 1, a counter substrate 2, and a liquid crystal layer 3, and on the active matrix substrate 1 side, has a touch surface. The active matrix substrate 1 includes a plurality of pixel electrodes 25, a plurality of counter electrodes 23, and a plurality of signal lines 24 on the liquid crystal layer 3 side of the substrate 100. The counter electrodes 23 detect a touch with respect to the touch surface, form capacitances between the same and the pixel electrodes 25, and are connected with the signal lines 24. The pixel electrodes 25 and the counter electrodes 23 are arranged so as to overlap with each other when viewed in a plan view, and the counter electrodes 23 are arranged at positions closer to the substrate 100 than the pixel electrodes 25 are. The counter substrate 2 includes, on a surface thereof on a side opposite to the liquid crystal layer 3 side, shield electrodes 202 that are arranged so as to overlap with the counter electrodes 23 when viewed in a plan view and have a reference potential (ground potential).

### TECHNICAL FIELD

The present invention relates to a touch-panel-equipped display device.

### BACKGROUND ART

JP-A-2015-122057 discloses a touch screen panel integrated display device that includes a panel that serves as both of a display and a touch screen. The panel includes an upper substrate provided with color filters, a lower substrate in which a plurality of pixels are formed, and a liquid crystal layer provided between the upper substrate and the lower substrate. Each pixel of the substrate is provided with a pixel electrode, and a transistor connected to the pixel electrode. Further, on the lower substrate, a plurality of electrodes are arranged so as to be opposed to the pixel electrodes, to be separated from the pixel electrodes. The plurality of electrodes function as common electrodes that form lateral electric fields (horizontal electric fields) between the same and the pixel electrodes in the display driving mode, and function as touch electrodes that form electrostatic capacitors between the same and a finger or the like in the touch driving mode. Each of the plurality of electrodes is connected to at least one signal line, approximately parallel with data lines, so that a touch driving signal or a common voltage signal is supplied thereto via the signal line.

### SUMMARY OF THE INVENTION

In the case of JP-A-2015-122057, the liquid crystal layer is provided between the upper substrate to be touched by a user's finger, and the electrodes of the lower substrate that detect the touch. If a change occurring to the electrostatic capacitance when the upper substrate is touched is small, a change in the liquid crystal capacitance caused by an image displaying operation makes it difficult to detect the change in the electrostatic capacitance when the user's finger is touched with the upper substrate. Further, if the whole of panel is warped when the upper substrate is touched, the distances between the electrodes of the lower substrate and other elements change, which causes the capacitances at the electrodes to change. In this case, changes in the capacitances caused by the warp of the whole of panel make it difficult to detect the changes in the electrostatic capacitances when the upper substrate is touched.

It is an object of the present invention to provide a touch-panel-equipped display device in which the touch detection sensitivity can be improved.

A touch-panel-equipped display device in one embodiment of the present invention is a touch-panel-equipped display device that includes an active matrix substrate, a counter substrate provided so as to be opposed to the active matrix substrate, and a liquid crystal layer provided between the active matrix substrate and the counter substrate, and that has a touch surface on an active matrix substrate side. The active matrix substrate includes a plurality of pixel electrodes, a plurality of counter electrodes to detect a touch with respect to the touch surface and make capacitances between the same and the pixel electrodes, and a plurality of signal lines connected with the counter electrodes, on a liquid crystal layer side of the substrate. The counter substrate includes, on a surface thereof on a side opposite to the liquid crystal layer side, shield electrodes that are arranged so as to overlap with the counter electrodes when viewed in a plan view and have a reference potential. The pixel electrodes and the counter electrodes are arranged so as to overlap with each other when viewed in a plan view, and the counter electrodes are arranged at positions closer to the substrate than the pixel electrodes are.

With the present invention, the touch detection sensitivity can be improved.

### BRIEF DESCRIPTION OF DRAWINGS

FIG. 1 is a cross-sectional view of a touch-panel-equipped display device according to Embodiment 1.

FIG. 2 schematically shows a schematic configuration of an active matrix substrate shown in FIG. 1.

FIG. 3 schematically shows an exemplary arrangement of counter electrodes.

FIG. 4 is an enlarged schematic diagram showing a part of an area of the active matrix substrate shown in FIG. 1.

FIG. 5 is a cross-sectional view of the active matrix substrate in the touch-panel-equipped display device, taken along line A-A in FIG. 4.

FIG. 6 is a cross-sectional view of the active matrix substrate in the touch-panel-equipped display device, taken along line B-B in FIG. 4.

FIG. 7A is a cross-sectional view showing a process of producing a TFT area and a non-TFT area of the active matrix substrate shown in FIG. 1, which is a cross-sectional view showing a step of forming a black matrix on a glass substrate.

FIG. 7B is a cross-sectional view showing a step of forming an inorganic insulating film 102 covering the black matrix shown in FIG. 7A.

FIG. 7C is a cross-sectional view showing a step of forming a source electrode and a drain electrode, as well as a data line on the inorganic insulating film 102 shown in FIG. 7B.

FIG. 7D is a cross-sectional view showing a step of forming a semiconductor film on the source electrode and the drain electrode shown in FIG. 7C.

FIG. 7E is a cross-sectional view showing a step of forming a gate insulating film that covers the source electrode, the drain electrode, and the semiconductor film, as well as the data line shown in FIG. 7D.

FIG. 7F is a cross-sectional view showing a step of forming a gate electrode on the gate insulating film in a TFT area shown in FIG. 7E.

FIG. 7G is a cross-sectional view showing a step of forming an organic insulating film on the gate electrode and the gate insulating film shown in FIG. 7F.

FIG. 7H is a cross-sectional view showing a step of forming a counter electrode on the organic insulating film shown in FIG. 7G.

FIG. 7I is a cross-sectional view showing a step of forming an inorganic insulating film 105 that covers the counter electrode shown in FIG. 7H.

FIG. 7J is a cross-sectional view showing a step of forming a contact hole in the inorganic insulating film 105 shown in FIG. 7I.

FIG. 7K is a cross-sectional view showing a step of forming a pixel electrode on the inorganic insulating film 105 shown in FIG. 7J.

FIG. 7L is a cross-sectional view showing a step of forming a signal line on the inorganic insulating film 105 shown in FIG. 7K.

FIG. 8 is a cross-sectional view for explaining an arrangement of the counter electrodes and the data lines on the active matrix substrate.

FIG. 9 is a schematic cross-sectional view of a non-TFT area in an active matrix substrate according to Embodiment 2.

FIG. 10A is a cross-sectional view for explaining a process of producing an active matrix substrate shown in FIG. 9, which shows a step of forming a signal line on an organic insulating film.

FIG. 10B is a cross-sectional view showing a step of forming an inorganic insulating film 105 that covers the signal line shown in FIG. 10A.

FIG. 10C is a cross-sectional view showing a step of forming a counter electrode on the inorganic insulating film 105 shown in FIG. 10B.

FIG. 10D is a cross-sectional view showing a step of forming an inorganic insulating film 106 that covers the counter electrode shown in FIG. 10C.

FIG. 11 is a schematic cross-sectional view of a non-TFT area in an active matrix substrate according to Embodiment 3.

FIG. 12A is a cross-sectional view for explaining a process of producing an active matrix substrate shown in FIG. 11, which shows a step of forming a signal line on an organic insulating film.

FIG. 12B is a cross-sectional view showing a step of forming a counter electrode on the organic insulating film shown in FIG. 12A.

FIG. 12C is a cross-sectional view showing a step of forming an inorganic insulating film 105 that covers the counter electrode and the signal line shown in FIG. 12B.

FIG. 12D is a cross-sectional view showing a step of forming a pixel electrode on the inorganic insulating film 105 shown in FIG. 12C.

FIG. 12E is a cross-sectional view showing a step of forming an inorganic insulating film 106 that covers the pixel electrode shown in FIG. 12D.

FIG. 12F is a cross-sectional view showing a step of forming a common electrode on the inorganic insulating film 106 shown in FIG. 12E.

### MODE FOR CARRYING OUT THE INVENTION

A touch-panel-equipped display device in one embodiment of the present invention is a touch-panel-equipped display device that includes an active matrix substrate, a counter substrate provided so as to be opposed to the active matrix substrate, and a liquid crystal layer provided between the active matrix substrate and the counter substrate, and that has a touch surface on an active matrix substrate side. The active matrix substrate includes a plurality of pixel electrodes, a plurality of counter electrodes to detect a touch with respect to the touch surface and make capacitances between the same and the pixel electrodes, and a plurality of signal lines connected with the counter electrodes, on a liquid crystal layer side of the substrate. The counter substrate includes, on a surface thereof on a side opposite to the liquid crystal layer side, shield electrodes that are arranged so as to overlap with the counter electrodes when viewed in a plan view and have a reference potential. The pixel electrodes and the counter electrodes are arranged so as to overlap with each other when viewed in a plan view, and the counter electrodes are arranged at positions closer to the substrate than the pixel electrodes are (the first configuration).

According to the first configuration, the touch-panel-equipped display device has a touch surface on the active matrix substrate side, and there are provided a plurality of pixel electrodes, a plurality of counter electrodes, and a plurality of signal lines on the liquid crystal layer side of the active matrix substrate. The counter electrodes are used in an image displaying operation, detect a touch with respect to the touch surface, and are arranged at positions closer to the substrate than the pixel electrodes are. In other words, the liquid crystal layer is not provided between the touch surface and the counter electrodes. Accordingly, even if an image displaying operation causes a capacitance change to occur in the liquid crystal layer, the detection is not affected by the change in the liquid crystal capacitance, as compared with a case where the liquid crystal layer is between the touch surface and the counter electrodes. This therefore makes it possible to detect a small capacitance change when a touch is made. Further, on the surface on the liquid crystal layer side of the counter substrate, the shield electrodes having a reference potential are provided. For this reason, even if the touch-panel-equipped display device is warped when a user's finger or the like touches the device, a change in the electrostatic capacitances between the counter electrodes and the members provided on the back surface side of the counter substrate can be reduced, which therefore makes it possible to detect a capacitance change when the touch surface is touched.

The first configuration may be further characterized in that the active matrix substrate further includes a plurality of gate lines, and a plurality of data lines that intersect with the gate lines, on the liquid crystal layer side of the substrate; the counter electrodes are arranged so as to be arrayed in a gate line extending direction and a data line extending direction; and at least one data line is arranged between adjacent ones of the counter electrodes that are adjacent in the gate line extending direction when viewed in a plan view (the second configuration).

According to the second configuration, at least one data line is arranged between adjacent ones of the counter electrodes that are adjacent in the gate line extending direction. This makes it unlikely that external electric fields from the touch surface side would affect the liquid crystal layer, which results in that alignment defects in the liquid crystal layer can be reduced.

The first or second configuration may be further characterized in that the active matrix substrate further includes a plurality of gate lines, and a plurality of data lines that intersect with the gate lines, on the liquid crystal layer side of the substrate; the counter electrodes are arranged so as to be arrayed in a gate line extending direction and a data line extending direction; and at least one gate line is arranged between adjacent ones of the counter electrodes that are adjacent in the data line extending direction when viewed in a plan view (the third configuration).

According to the third configuration, at least one gate line is arranged between adjacent ones of the counter electrodes that are adjacent in the data line extending direction. This makes it unlikely that external electric fields from the touch surface side would affect the liquid crystal layer, which results in that alignment defects in the liquid crystal layer can be reduced.

Any one of the first to third configurations may be further characterized in that the signal lines and the pixel electrodes are arranged in different layers (the fourth configuration).

With the fourth configuration, alignment defects in the liquid crystal layer caused by electrostatic capacitances between the pixel electrodes and the signal lines can be reduced, as compared with a case where the pixel electrodes and the signal lines are arranged in the same layer.

Any one of the first to fourth configurations may be further characterized in that the active matrix substrate further includes: a first insulating film that is arranged between the counter electrodes and the pixel electrodes; a second insulating film that is arranged on a side opposite to the counter electrodes with respect to the pixel electrodes, and covers the pixel electrodes; and a transparent electrode that is arranged so as to overlap with the pixel electrodes with the second insulating film being interposed therebetween, and is electrically connected with the counter electrodes (the fifth configuration).

According to the fifth configuration, the pixel electrodes are arranged between the counter electrodes and the transparent electrode, with the first insulating film being interposed between the pixel electrodes and the counter electrodes, and the second insulating film being interposed between the pixel electrodes and the transparent electrode; and the transparent electrode is electrically connected with the counter electrodes. This makes it possible to increase pixel capacitances, thereby improving the display quality, as compared with a case where only the counter electrodes are provided.

Any one of the first to fifth configurations may be further characterized in that the active matrix substrate further includes a plurality of switching elements each of which includes a source electrode, a drain electrode, a semiconductor film, and a gate electrode; and the gate electrode is provided on the liquid crystal layer side with respect to the semiconductor film (the sixth configuration).

According to the sixth configuration, the gate electrodes of the switching elements are provided on the liquid crystal layer side with respect to the semiconductor films. In other words, the switching element has a top gate structure with respect to the substrate. This makes it unlikely that light from the back side of the touch-panel-equipped display device would enter the channel area of the switching element, which makes it unnecessary to additionally provide a light-shielding film.

Any one of the first to fifth configurations may be further characterized in that the active matrix substrate further includes a plurality of switching elements each of which includes a source electrode, a drain electrode, a semiconductor film, and a gate electrode, and the gate electrode is provided on the substrate side with respect to the semiconductor film (the seventh configuration).

According to the seventh configuration, the gate electrodes are provided on the substrate side with respect to the semiconductor film. This therefore makes it possible to block light from the substrate side that would enter the channel area of the switching element.

Any one of the first to seventh configurations may be further characterized in that the active matrix substrate further includes a light-shielding section between the pixel electrodes and the substrate (the eighth configuration).

With the eighth configuration, external light from the surface of the substrate on a side opposite to the liquid crystal layer can be blocked.

The eighth configuration may be further characterized in that the light-shielding section is arranged at a position that does not overlap with the pixel electrodes (the ninth configuration).

With the ninth configuration, the light-shielding section does not overlap with the pixel electrodes, whereby the aperture ratio of the pixels can be improved.

### Embodiment 1

The following description describes embodiments of the present invention in detail, while referring to the drawings. Identical or equivalent parts in the drawings are denoted by the same reference numerals, and the descriptions of the same are not repeated. To make the description easy to understand, in the drawings referred to hereinafter, the configurations are simply shown or schematically shown, or the illustration of a part of constituent members is omitted. Further, the dimension ratios of the constituent members shown in the drawings do not necessarily indicate the real dimension ratios.

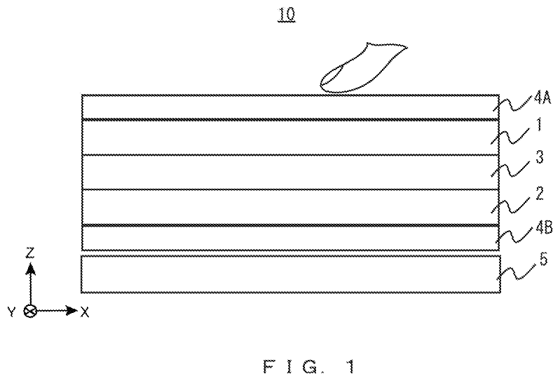

FIG. 1 is a cross-sectional view of a touch-panel-equipped display device 10 according to the present embodiment. The touch-panel-equipped display device 10 according to the present embodiment includes an active matrix substrate 1, a counter substrate 2, a liquid crystal layer 3 interposed between the active matrix substrate 1 and the counter substrate 2, a pair of polarizing plates 4A, 4B, and a backlight 5.

The touch-panel-equipped display device 10 has a function of displaying an image and has a function of detecting a position (touch position) at which a finger of a user or the like touches on the displayed image, that is, on a surface on the polarizing plate 4A provided in the active matrix substrate 1 side.

Besides, this touch-panel-equipped display device 10 is a so-called in-cell type touch panel display device in which elements necessary for detecting a touch position are provided on the active matrix substrate 1. Further, in the touch-panel-equipped display device 10, the method for driving liquid crystal molecules included in the liquid crystal layer 3 is the horizontal electric field driving method. To realize the horizontal electric field driving method, pixel electrodes and counter electrodes (common electrodes) for forming electric fields are formed on the active matrix substrate 1.

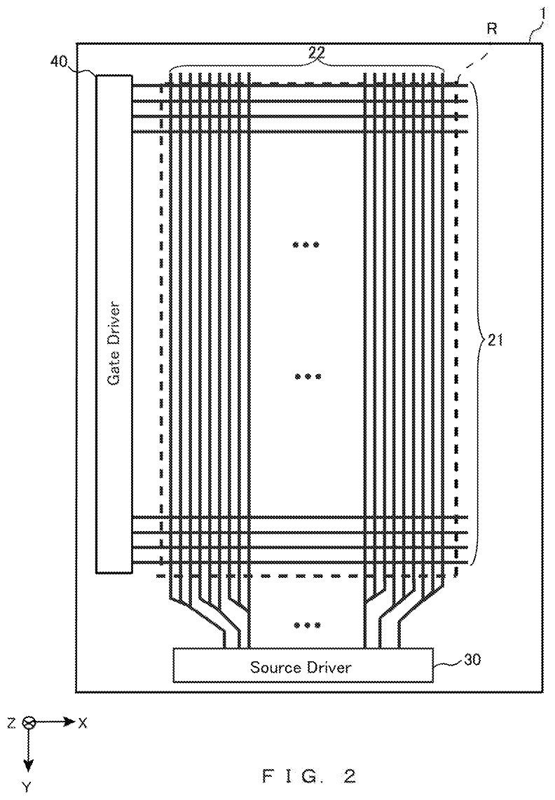

FIG. 2 schematically shows a schematic configuration of the active matrix substrate 1. The active matrix substrate 1 includes a plurality of gate lines 21 and a plurality of data lines 22 on its surface on the liquid crystal layer 3 side (see FIG. 1). The active matrix substrate 1 includes a plurality of pixels defined by the gate lines 21 and the data lines 22, and an area where the pixels are formed is a display area R of the active matrix substrate 1.

In each pixel, a pixel electrode and a switching element are arranged. For forming the switching element, for example, a thin film transistor is used.

The active matrix substrate 1 includes a source driver 30 and a gate driver 40 in an area (frame area) outside the display area R. The source driver 30 is connected with each data line 22, and supplies voltage signals to the data lines 22 in accordance with image data, respectively. The gate driver 40 is connected with each gate line 21, and sequentially supplies a voltage signal to the gate lines 21 so as to scan the gate lines 21.

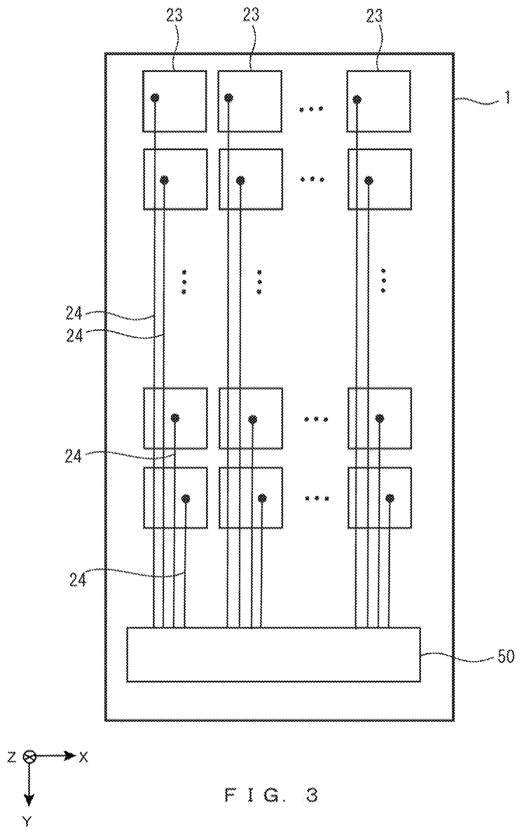

FIG. 3 schematically shows an exemplary arrangement of counter electrodes. The counter electrodes 23 are formed on a liquid crystal layer 3 side surface (see FIG. 1) of the active matrix substrate 1. As shown in FIG. 3, the counter electrode 23 is in a rectangular shape, and a plurality of the same are arranged in matrix on the active matrix substrate 1. The counter electrode 23 is, for example, in an approximately square shape whose side is several millimeters.

Further, the active matrix substrate 1 is further provided with a controller 50. The controller 50 performs a controlling operation for detecting a touch position.

The controller 50 and the counter electrodes 23 are connected by signal lines 24 extending in the Y axis direction. In other words, the same number of signal lines 24 as the number of the touch detection electrodes 23 are formed on the active matrix substrate 1.

The counter electrodes 23 in pairs with the pixel electrodes are used during the controlling operation for displaying an image, and are also used during the controlling operation for detecting a touch position.

Regarding the counter electrodes 23, parasitic capacitances occur between the same and adjacent ones of the counter electrodes 23, other elements, or the like when nothing is in contact with the touch surface. When a human finger or the like touches the display screen of the display device 10, capacitors occur between the same and the human finger or the like, and thereby electrostatic capacitances increase. During the control for touch position detection, the controller 50 supplies a touch driving signal for detecting a touch position, to the counter electrodes 23 through the signal lines 24, and receives a touch detection signal through the signal lines 24. By doing so, the controller 50 detects changes in the electrostatic capacitances at the positions of the counter electrodes 23, and detects a touch position. Further, a predetermined voltage signal is supplied to the signal line 24 by the controller 50 during the controlling operation for displaying an image, and supplies the predetermined voltage signal to the counter electrode 23. In other words, the signal line 24 functions as a line for transmission/reception of the touch driving signal and the touch detection signal, and the counter electrodes 23 function as a common electrode that makes a horizontal electric field between itself and the pixel electrodes.

FIG. 4 is an enlarged plan view showing a part of the active matrix substrate 1. As shown in FIG. 4, the pixel electrodes 25 are arranged in matrix. Further, though the illustration is omitted in FIG. 4, thin film transistors (TFTs) as switching elements are arranged in matrix so as to correspond to the pixel electrodes 25, respectively.

The pixel electrodes 25 are provided in pixel areas defined by the gate lines 21 and the data lines 22. The gate electrode of the above-described TFT is connected to the gate line 21, and either of the source electrode and the drain electrode is connected with the data line 22, while the other is connected with the pixel electrode 25.

As shown in FIG. 4, the signal lines 24 extending in the Y-axis direction are arranged so as to partially overlap with the data lines 22 in the normal line direction (Z-axis direction) of the active matrix substrate 1, the data lines 22 extending in the Y-axis direction. More specifically, the signal line 24 is provided on a side in the Z-axis negative direction with respect to the data line 22 so that the signal line 24 and the data line 22 partially overlap with each other when viewed in a plan view.

In FIG. 4, white circles 35 is a portion at which the counter electrodes 23 and the signal lines 24 are connected with each other.

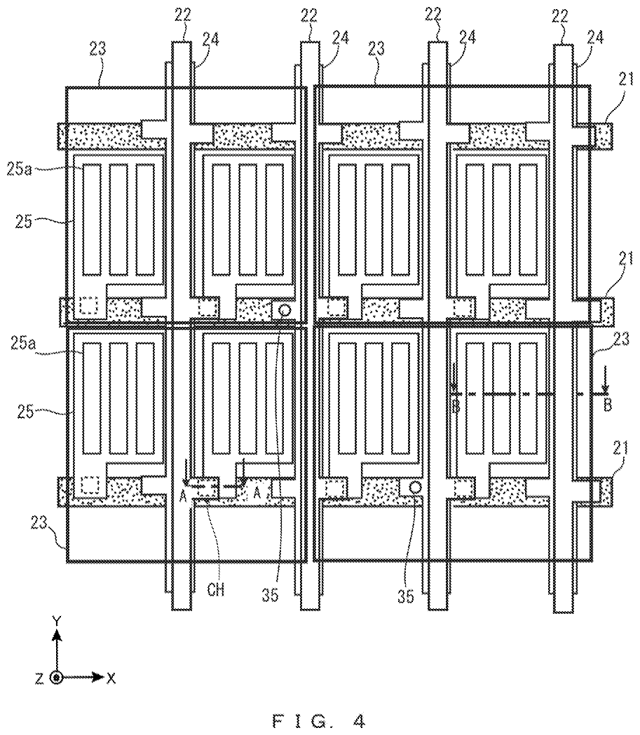

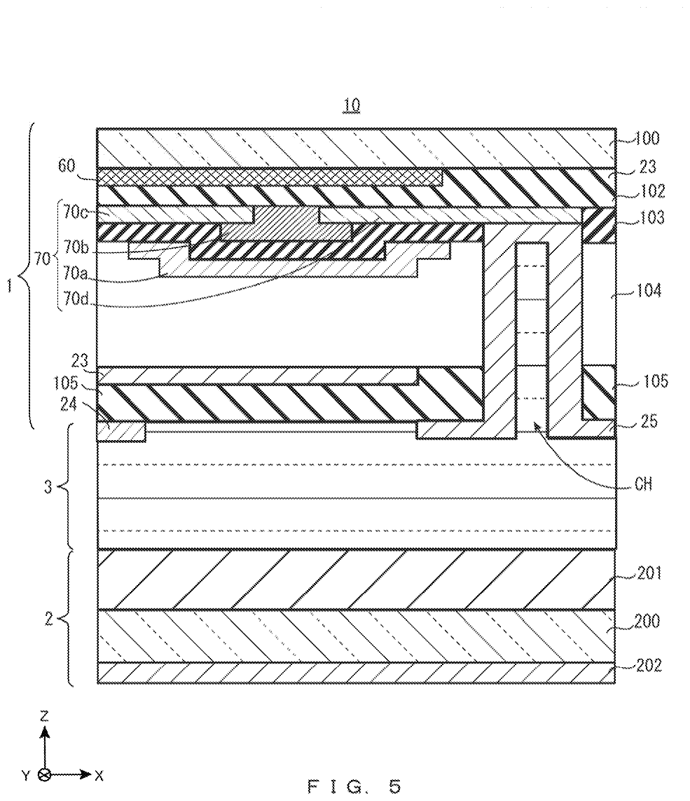

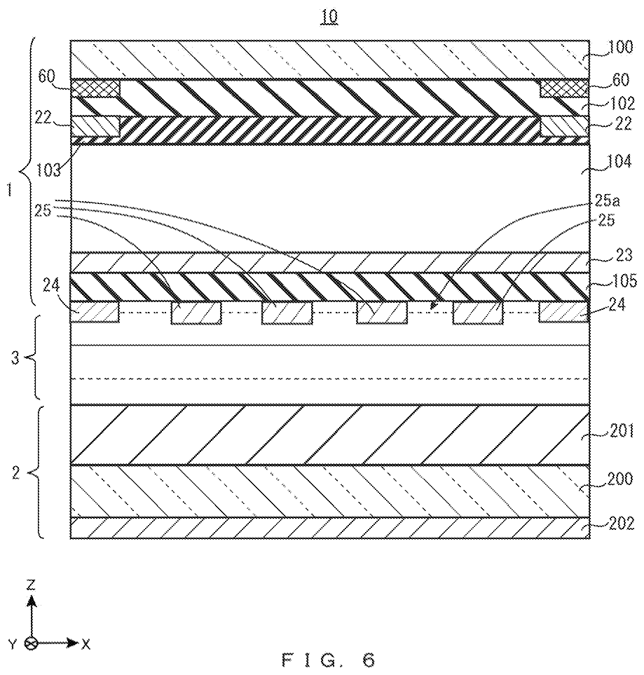

FIG. 5 shows a cross section of the active matrix substrate 1 in the touch-panel-equipped display device 10 taken along line A-A in FIG. 4 showing. In other words, FIG. 5 is a schematic cross-sectional view of an area thereof where the TFT is arranged (TFT area). Further, FIG. 6 is a cross-sectional view of the active matrix substrate 1 in the touch-panel-equipped display device 10 taken along line B-B in FIG. 4. In other words, FIG. 6 is a schematic cross-sectional view of an area thereof where the TFT is not arranged (non-TFT area). The following description describes a cross-sectional structure of the active matrix substrate 1 and the counter substrate 2.

### Cross-Sectional Structure of Active Matrix Substrate

As shown in FIGS. 5 and 6, a black matrix 60 is arranged on the liquid crystal layer 3 side surface of the glass substrate 100 in the active matrix substrate 1. As shown in FIGS. 5, 6, the black matrix 60 is arranged so as to overlap with the TFTs 70 and the data lines 22 when viewed in a plan view. The black matrix 60 is preferably made of a material having a low reflectance so as to reduce decrease in contrast due to reflection of external light (glare), and fluctuations in properties of the TFTs 70 due to internal reflection of backlight light.

Further, as shown in FIGS. 5 and 6, an inorganic insulating film 102 is arranged on the liquid crystal layer 3 side surface of the glass substrate 100, so as to cover the black matrix 60. The inorganic insulating film 102 is made of, for example, silicon nitride (SiNₓ) or silicon dioxide (SiO₂).

As shown in FIG. 5, in the TFT area, TFTs 70 are formed on the surface of the inorganic insulating film 102. The TFT 70 includes a gate electrode 70a, a semiconductor film 70b, a source electrode 70c, and a drain electrode 70d. The source electrode 70c and the drain electrode 70d are arranged in contact with the inorganic insulating film 102. Further, as shown in FIG. 6, in the non-TFT area, the data line 22 is arranged on the surface of the inorganic insulating film 162 at a position that overlaps with the black matrix 60. The source electrode 70c and the drain electrode 70d as well as the data line 22 are formed with, for example, a laminate film of titanium (Ti) and copper (Cu).

The semiconductor film 70b is arranged so as to overlap with parts of the source electrode 70c and the drain electrode 70d. The semiconductor film 70b is, for example, an oxide semiconductor film, and may contain at least one metal element among In, Ga, and Zn. In the present embodiment, the semiconductor film 70b contains, for example, In—Ga—Zn—O-based semiconductor. Here, the In—Ga—Zn—O-based semiconductor is a ternary oxide of indium (In), gallium (Ga), and zinc (Zn), in which the ratio (composition ratio) of In, Ga, and Zn is not limited particularly, and examples of the ratio include In:Ga:Zn=2:2:1, In:Ga:Zn=1:1:1, and In:Ga:Zn=1:1:2.

As shown in FIGS. 5 and 6, a gate insulating film 103 is arranged so as to overlap with the source electrode 70c, the drain electrode 70d, and the semiconductor film 70b in the TFT area, and to overlap with the data lines 22 in the non-TFT area. The gate insulating film 103 is made of, for example, silicon nitride (SiNₓ) or silicon dioxide (SiO₂).

As shown in FIG. 5, the gate electrode 70a is in contact with the gate insulating film 103, and is arranged on a side lower with respect to the semiconductor film 70b (on the side in the Z-axis negative direction), that is, on the liquid crystal layer 3 side. The gate electrode 70a is formed with, for example, a laminate film of titanium (Ti) and copper (Cu).

As shown in FIGS. 5 and 6, in the TFT area and the non-TFT area, an organic insulating film (flattening film) 164 is arranged so as to cover the gate electrode 70a and the gate insulating film 103. The organic insulating film 104 is made of, for example, acryl-based organic resin material such as polymethyl methacrylate resin (PMMA). In this example, the organic insulating film 104 has a specific dielectric constant of 3 to 4, and has a thickness of 1 to 3 μm. The organic insulating film 104 is arranged so as to reduce a capacitance between the gate line 21 as well as the data line 22, and the counter electrode 23, but the organic insulating film 104 does not have to be arranged necessarily. For example, in place of the organic insulating film 104, an inorganic insulating film such as silicon nitride (SiNₓ) may be arranged. The inorganic insulating film preferably has a thickness of, for example, 0.4 to 0.9 μm in this case.

As shown in FIGS. 5 and 6, the counter electrode 23 is arranged on the surface of the organic insulating film 104, and an inorganic insulating film 105 is arranged so as to cover the counter electrode 23. The counter electrodes 23 are transparent electrodes, and are made of a material such as ITO, ZnO, IZO (In—Zn—O), IGZO (In—Ga—Zn—O), or ITZO (In-Tin-Zn—O). The inorganic insulating film 105 is made of, for example, silicon nitride (SiNₓ) or silicon dioxide (SiO₂).

As shown in FIG. 5, in the TFT area, a contact hole CH passing through the gate insulating film 103, the organic insulating film 104, and the inorganic insulating film 105 is provided at a position that overlaps with the drain electrode 70d.

As shown in FIGS. 5 and 6, the pixel electrode 25 and the signal line 24 are arranged on the surface of the inorganic insulating film 105. As shown in FIG. 5, in the TFT area, the pixel electrode 25 is in contact with the drain electrode 70d through the contact hole CH. Further, as shown in FIG. 6, in the non-TFT area, slits 25a are formed in the pixel electrode 25. The pixel electrode 25 is a transparent electrode made of a material such as ITO, ZnO, IZO (In—Zn—O), IGZO (In—Ga—Zn—O), or ITZO (In-Tin-Zn—O).

As shown in FIGS. 5 and 6, the signal line 24 is formed at a position that overlaps with the data line 22 when viewed in a plan view. The signal line 24 is made of any one of, for example, copper (Cu), titanium (Ti), molybdenum (Mo), aluminum (Al), magnesium (Mg), cobalt (Co), chromium (Cr), and tungsten (W), or alternatively a mixture of any of these. Alternatively, the signal line 24 may be formed with a laminate film composed of a plurality of layers, for example, a laminate film in which the lowermost layer in contact with the inorganic insulating film 105 is made of the same material as that of the pixel electrode 25.

### Cross-Sectional Structure of Counter Substrate 2

As shown in FIGS. 5 and 6, the color filter and the overcoat layer 201 are laminated so as to cover one of the surfaces of the glass substrate 200 in the counter substrate 2, that is, the surface on the liquid crystal layer 3 side (on the side in the Z-axis positive direction). Further, a shield electrode 202 is provided so as to cover the other surface of the glass substrate 200, that is, the surface on the polarizing plate 4B side (see FIG. 1) (on the side in the Z-axis negative direction). The shield electrode 202 is a transparent electrode film made of a material such as, for example, ITO, ZnO, IZO (In—Zn—O), IGZO (In—Ga—Zn—O), or ITZO (In-Tin-Zn—O). The shield electrode 202 is connected with a line (not illustrated) formed on the active matrix substrate 1 that supplies a reference potential (the ground potential).

### Producing Method

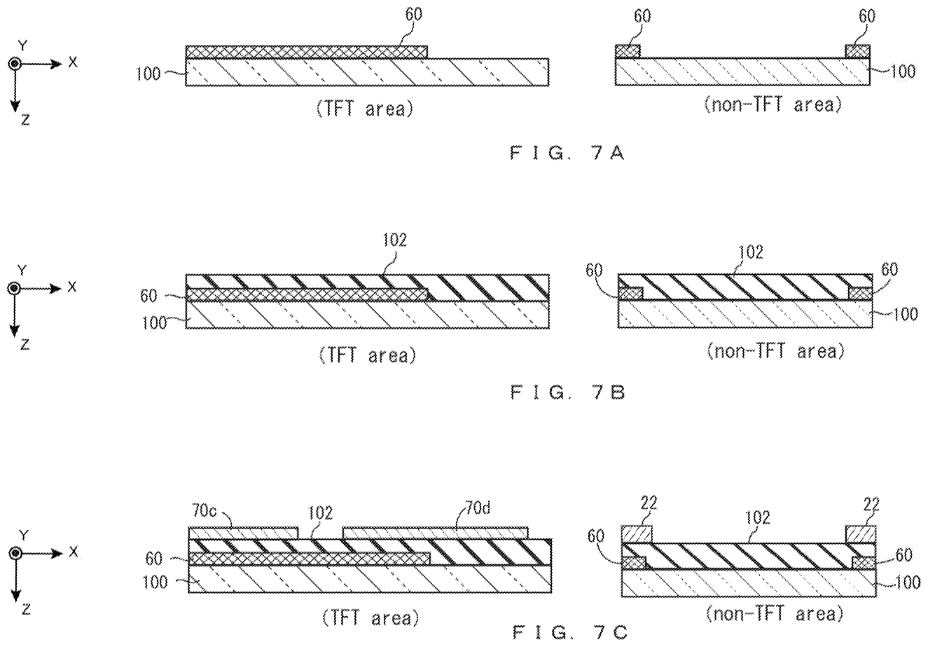

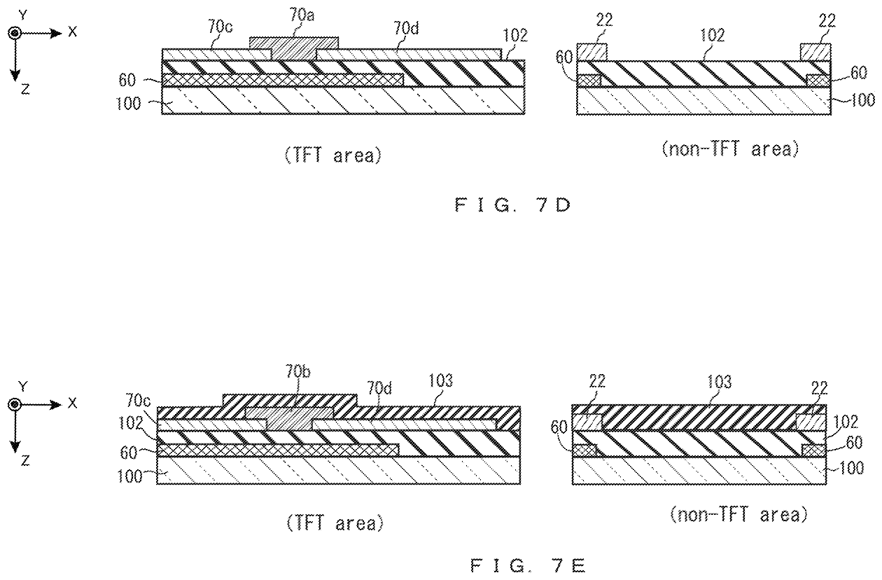

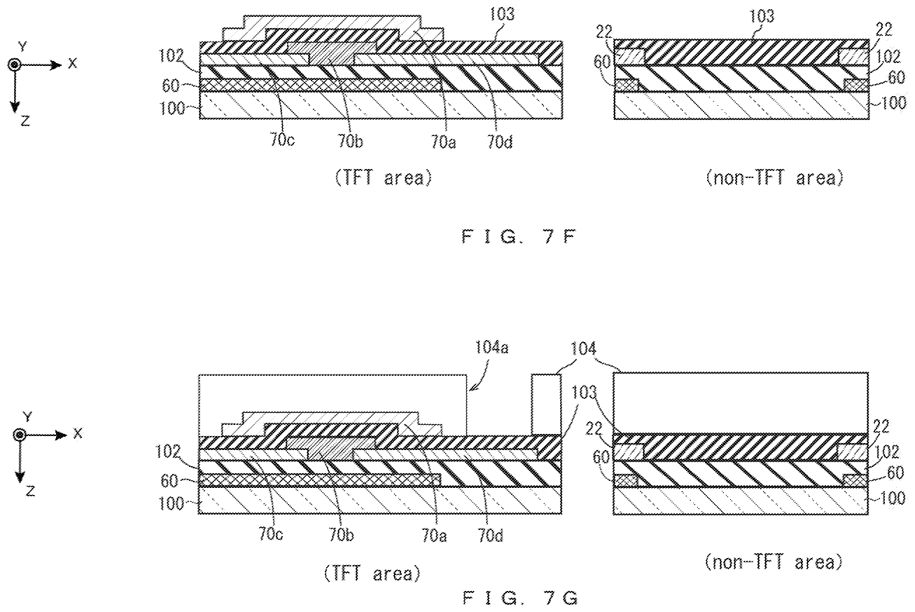

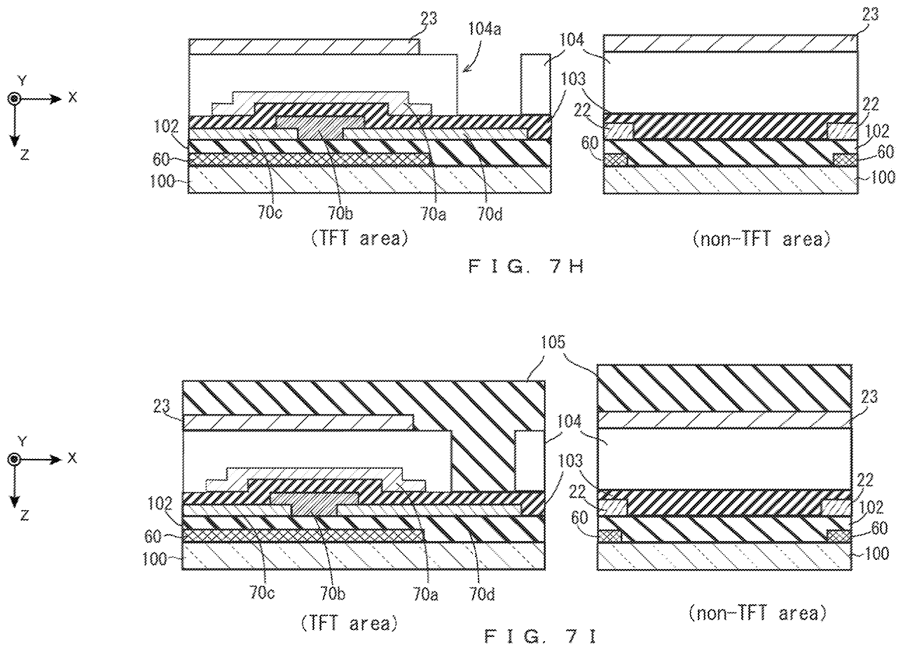

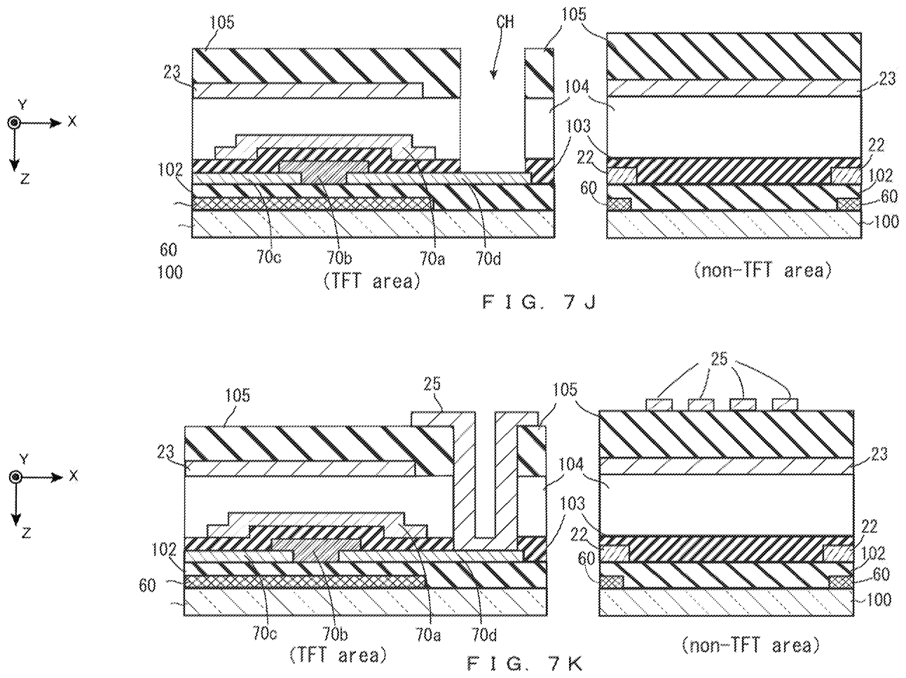

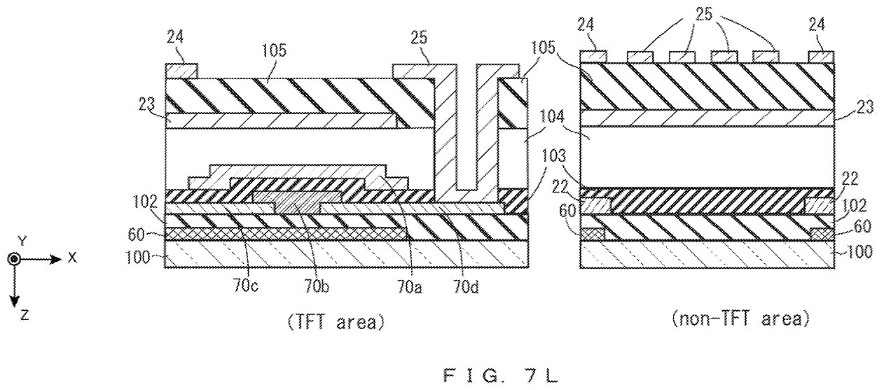

Next, the following description describes a method for producing the active matrix substrate 1. FIGS. 7A to 7L are cross-sectional views showing a process for producing the TFT area and the non-TFT area of the active matrix substrate 1. The following description describes the producing process while referring to FIGS. 7A to 7L.

First, a black resist is applied over one of the surfaces of the glass substrate 100, and is patterned by photolithography. Through this step, a black matrix 60 is formed in the TFT area and the non-TFT area (see FIG. 7A).

Next, an inorganic insulating film 102 made of, for example, silicon nitride (SiNₓ) is formed so as to cover the black matrix 60 on the glass substrate 100 (see FIG. 7B).

Subsequently, for example, a film of titanium (Ti) and a film of copper (Cu) are formed sequentially on the inorganic insulating film 102, and photolithography and wet etching are carried out so as to pattern the laminate film of titanium (Ti) and copper (Cu). Through these steps, the source electrode 70c and the drain electrode 70d are formed on the inorganic insulating film 102 in the TFT area. Further, the data line 22 is formed on the inorganic insulating film 102 in the non-TFT area (see FIG. 7C).

Next, a semiconductor film containing, for example, In, Ga, Zn, and O is formed so as to cover the source electrode 70c and the drain electrode 70d in the TFT area, and photolithography and wet etching are carried out so as to pattern the semiconductor film. Through these steps, in the TFT area, the semiconductor film 70b is formed so as to overlap with parts of the source electrode 70c and the drain electrode 70d (see FIG. 7D).

Then, the gate insulating film 103 made of, for example, silicon oxide (SiOₓ) is formed so as to cover the source electrode 70c, the drain electrode 70d, and the semiconductor film 70b in the TFT area, and cover the data line 22 in the non-TFT area (see FIG. 7E).

Subsequently, a laminate metal film obtained by laminating, for example, titanium (Ti) and copper (Cu) sequentially is formed on the gate insulating film 103, and photolithography and wet etching are carried out so as to pattern the laminate metal film. Through these steps, in the TFT area, the gate electrode 70a is formed at a position that overlaps with the source electrode 70c, the drain electrode 70d, and the semiconductor film 70b (see FIG. 7F).

Next, an organic insulating film is formed so as to cover the gate electrode 70a and the gate insulating film 103 in the TFT area and the gate insulating film 103 in the non-TFT area. Then, the organic insulating film is patterned by photolithography. Through this step, the organic insulating film 104 is formed that has an opening 104a at a position that overlaps with the drain electrode 70d in the TFT area (see FIG. 7G).

Then, a transparent electrode film made of, for example, ITO is formed on the organic insulating film 104, and then, photolithography and wet etching are carried out so as to pattern the transparent electrode film. Through this step, the counter electrode 23 is formed on the organic insulating film 104 in the TFT area and the non-TFT area (see FIG. 7H).

Next, the inorganic insulating film 105 made of, for example, silicon nitride (SiNₓ) is formed so as to cover the counter electrode 23 and the organic insulating film 104 in the TFT area and the counter electrode 23 in the non-TFT area (see FIG. 71). Then, photolithography and dry etching are carried out so as to pattern the inorganic insulating film 105 and the gate insulating film 103. Through this step, the contact hole CH passing through the gate insulating film 103 and the inorganic insulating film 105 in the TFT area is formed, and the inorganic insulating film 105 is formed in an area other than the contact hole CH (see FIG. 7J).

Then, a transparent electrode film made of, for example, ITO is formed on the inorganic insulating film 105, and then, photolithography and wet etching are carried out so as to pattern the transparent electrode film. Through these steps, the pixel electrode 25 is formed on the inorganic insulating film 105 in the TFT area and the non-TFT area. The pixel electrode 25 is in contact with the drain electrode 70d in the TFT area, and includes slits 25a (see FIG. 7K).

Next, a metal film made of, for example, copper (Cu) is formed on the inorganic insulating film 105, and then, photolithography and wet etching are carried out so as to pattern the metal film. Through these steps, in the TFT area and the non-TFT area, the signal line 24 is formed at a position that does not overlap with the pixel electrode 25 (see FIG. 7L). What is described above is an exemplary method for producing the active matrix substrate 1.

In the above-described embodiment, the counter electrodes 23 are on the glass substrate 100 side with respect to the pixel electrodes 25, and the liquid crystal layer 3 is not arranged between the touch surface and the counter electrodes 23. It is therefore unlikely that, during a touch detecting operation, the operation would be affected by changes in the liquid crystal capacitances, and a small change in the electrostatic capacitance when the touch surface is touched can be easily detected.

Further, shield electrodes are provided to reduce alignment defects caused in the liquid crystal layer 3 due to external electric fields in the horizontal electric field driving. In the above-described embodiment, shield electrodes 202 are provided on the backlight 5 side of the counter substrate 2, whereby alignment defects in the liquid crystal layer 3 caused by external electric fields from the counter substrate 2 side can be reduced. Further, in a case where the touch-panel-equipped display device 10 is of a thin type (for example, having a thickness of 0.3 to 0.6 mm), even if the touch-panel-equipped display device 10 is warped when a touch surface of the touch-panel-equipped display device 10 is touched, the shield electrodes 202 makes it unlikely that the electrostatic capacitances between the counter electrodes 23 and members provided on the back surface side of the touch-panel-equipped display device 10 (backlight and the like) would change, whereby decreases in the touch detection sensitivity can be reduced.

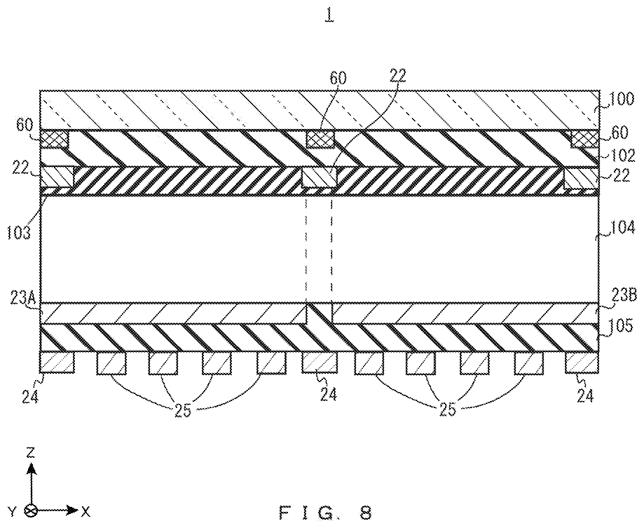

Further, in the above-described embodiment, the counter electrodes 23 are provided on the glass substrate 100 side with respect to the pixel electrodes 25, which allows the counter electrodes 23 to function as shield electrodes. This therefore makes it possible to improve the touch detection sensitivity, as compared with a case where the shield electrodes are provided on the side of the touch surface that a user's finger or the like touches in the glass substrate 100. In a case where the counter electrodes 23 are caused to function as shield electrodes in this way, it is preferable that the data lines 22 are arranged so that each overlaps with a space between adjacent ones of the counter electrodes 23 that are adjacent in the X-axis direction when viewed in a plan view in FIG. 4. In other words, as shown in FIG. 8, the data line 22 is preferably arranged between the counter electrodes 23A and 238 that are adjacent in the X-axis direction. This configuration makes it unlikely that the liquid crystal layer 3 would be affected by external electric fields from the touch surface side, as compared with a case where the data lines 22 are not arranged in such a manner that each is present between adjacent ones of the counter electrodes 23 that are adjacent in the X-axis direction. As a result, alignment defects in the liquid crystal layer 3 can be reduced.

Besides, each TFT 70 provided on the active matrix substrate 1 has such a top gate structure that the gate electrode 70a is arranged on the liquid crystal layer 3 side with respect to the semiconductor film 70b. This makes it unnecessary to additionally provide a light-shielding film for blocking light from the backlight 5 (see FIG. 1) so that the light should not enter the channel area of the TFT 70. Incidentally, light that enters the active matrix substrate 1 from the user side is blocked by the black matrix 60 provided on the active matrix substrate 1.

In the active matrix substrate 1, the counter electrodes 23 and the pixel electrodes 25 are arranged so as to overlap with each other (see FIG. 4 and the like). In other words, since the display area and the detection area overlap with each other in the active matrix substrate 1, the aperture ratio can be improved, as compared with a case where the detection area is provided separately from the display area.

The foregoing description of Embodiment 1 principally focuses on the TFT provided in the pixel, but the configuration of the gate driver 40 also include a plurality of TFTs. These TFT also may have a structure identical to that of the TFT 70 provided in the pixel.

### Embodiment 2

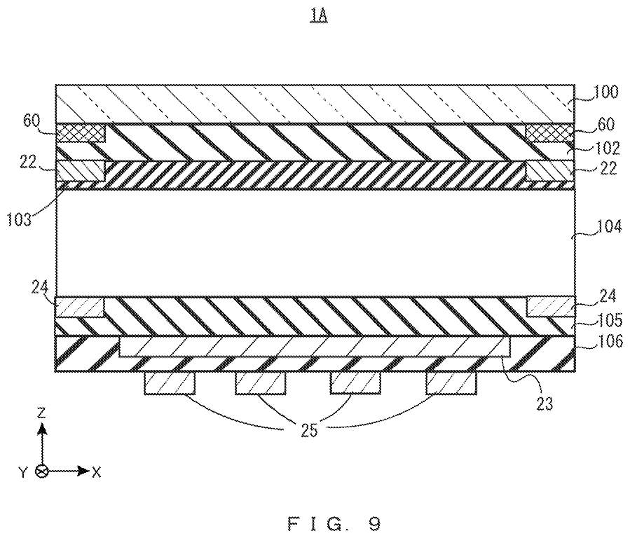

FIG. 9 is a cross-sectional view showing a non-TFT area of an active matrix substrate in the present embodiment. In FIG. 9, constituent members identical to those in Embodiment 1 are denoted by the same reference symbols in Embodiment 1, respectively. The following description describes configurations different from those of Embodiment 1.

As shown in FIG. 9, an active matrix substrate 1A in the present embodiment is different from the active matrix substrate 1 of Embodiment 1 in the following points, Specifically, in the active matrix substrate 1A, the signal lines 24 are arranged on the surface of the organic insulating film 104, and the counter electrodes 23 are arranged on the surface of the inorganic insulating film 105. Further, an inorganic insulating film 106 covering the counter electrodes 23 are arranged on the surface of the inorganic insulating film 105, and the pixel electrodes 25 are arranged on the surface of the inorganic insulating film 106. The inorganic insulating film 106 is made of, for example, silicon nitride (SiNₓ) or silicon dioxide (SiO₂).

In the present embodiment, as compared with Embodiment 1, the inorganic insulating film 106 is needed additionally, and the signal line 24 is arranged in another layer different from the layer where the pixel electrode 25 is provided. More specifically, the signal line 24 is arranged in a layer closer to the glass substrate 100 than the pixel electrode 25 is. In addition to the effects achieved in Embodiment 1, this makes it possible to achieve the following effects: the electrostatic capacitances between the signal lines 24 and the pixel electrodes 25 are reduced as compared with Embodiment 1, and alignment disturbances in the liquid crystal layer 3 caused by electrostatic capacitances between the signal lines 24 and the pixel electrodes 25 can be reduced.

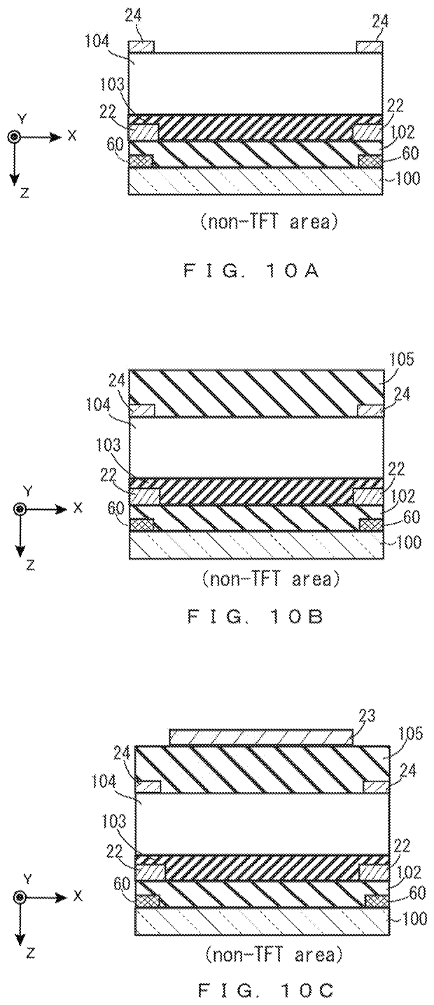

Incidentally, the production of the active matrix substrate 1A in the present embodiment is carried out as follows. After the steps shown in FIGS. 7A to 7G are carried out as is the case with Embodiment 1, a metal film made of, for example, copper (Cu) is formed on the organic insulating film 104, and then, photolithography and wet etching are carried out so as to pattern the metal film, Through these steps, the signal line 24 is formed on the organic insulating film 104, at a position that overlaps with the data line 22 when viewed in a plan view (see FIG. 10A).

Next, the inorganic insulating film 105 made of, for example, silicon nitride (SiNₓ) is formed on the organic insulating film 104 so as to cover the signal line 24 (see FIG. 10B).

Then, a transparent electrode film made of, for example, ITO is formed on the inorganic insulating film 105, and then, photolithography and wet etching are carried out so as to pattern the transparent electrode film. Through these steps, the counter electrode 23 is formed on the inorganic insulating film 105 at a position that does not overlap with the signal line 24 (see FIG. 10C).

Subsequently, the inorganic insulating film 106 made of, for example, silicon nitride (SiNₓ) is formed on the inorganic insulating film 105 so as to cover the counter electrode 23 (see FIG. 10D).

Then, as is the case with Embodiment 1, the step shown in FIG. 7K is carried out, whereby the pixel electrode 25 is formed on the inorganic insulating film 106.

### Embodiment 3

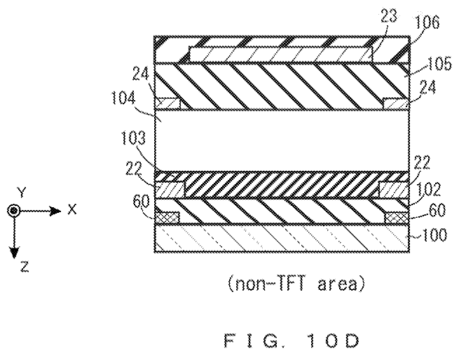

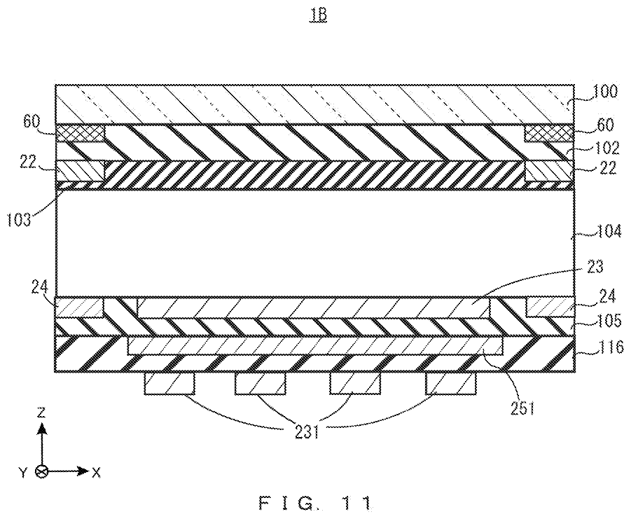

FIG. 11 is a cross-sectional view showing a non-TFT area of an active matrix substrate in the present embodiment. In FIG. 11, constituent members identical to those in Embodiment 1 are denoted by the same reference symbols in Embodiment 1, respectively. The following description describes configurations different from those of Embodiment 1.

As shown in FIG. 11, an active matrix substrate 1B in the present embodiment is different from the active matrix substrate 1 of Embodiment 1 in the following points. More specifically, in the case of the active matrix substrate 1B, the signal lines 24 are arranged on the surface of the organic insulating film 104, and an inorganic insulating film 116 is additionally arranged on the surface of the inorganic insulating film 105. Further, pixel electrodes 251 having no slit are arranged on the surface of the inorganic insulating film 105, and common electrodes 231 having slits are provided on the surface of the inorganic insulating film 116 in such a manner that the common electrodes 231 are separated from one another.

The inorganic insulating film 116 is made of, for example, silicon nitride (SiNₓ) or silicon dioxide (SiO₂). The common electrode 231 is made of the same material as that of the counter electrode 23. The common electrode 231 is connected with the counter electrode 23, and when an image is displayed, the common electrode 231 has the same potential as that of the counter electrode 23, forming a capacitor between itself and the pixel electrode 251.

The present embodiment includes the counter electrodes 23 and the common electrodes 231 on the glass substrate 100 side and on the liquid crystal layer 3 side (see FIG. 1 and the like), respectively, with respect to the pixel electrodes 251. In addition to the above-described effects achieved in Embodiment 1, this makes it possible to achieve the following effects: when an image is displayed, pixel capacitances can be increased as compared with Embodiment 1, and display defects such as flicker and shadowing can be reduced. Further, in the present embodiment, the signal lines 24 and the pixel electrodes 251 are provided in different layers. respectively. This causes electrostatic capacitances between the signal lines 24 and the pixel electrodes 251 to decrease, thereby reducing alignment disturbances in the liquid crystal layer caused by electrostatic capacitances between the signal lines 24 and the pixel electrodes 251.

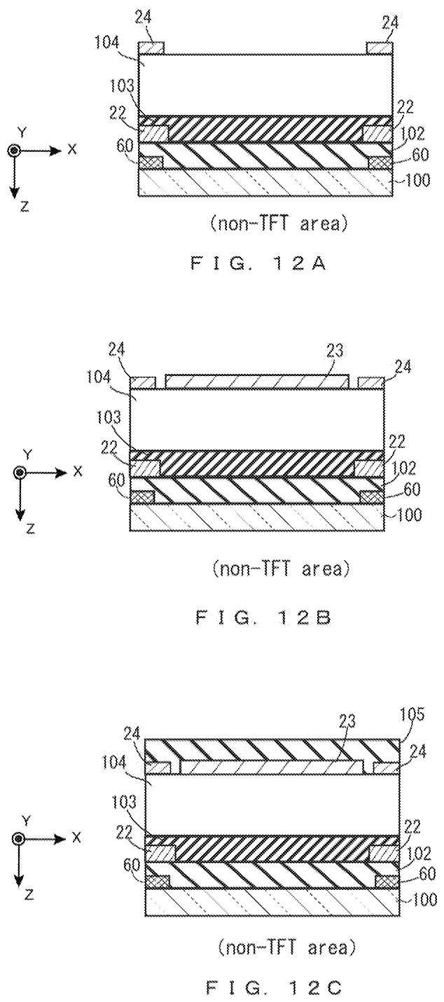

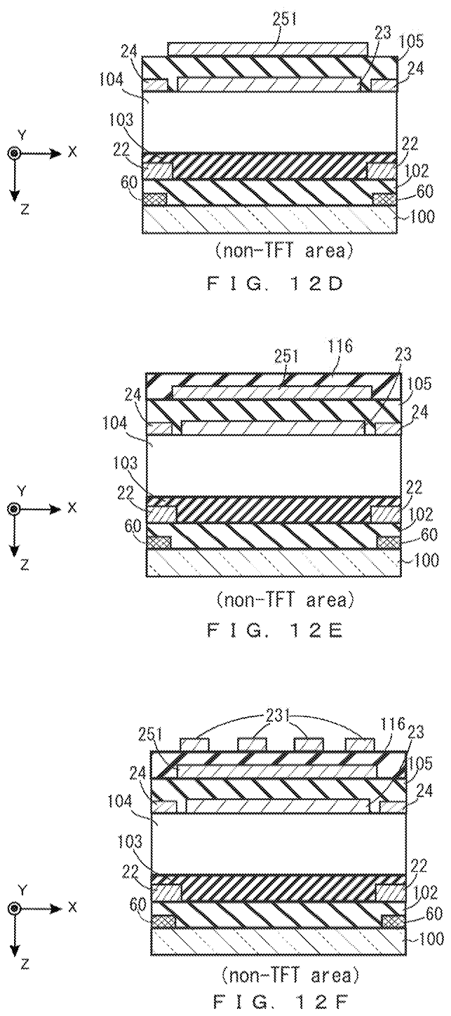

Incidentally, the production of the active matrix substrate 1B in the present embodiment is carried out as follows. After the steps shown in FIGS. 7A to 7G are carried out as is the case with Embodiment 1, a metal film made of, for example, copper (Cu) is formed on the organic insulating film 104, and then, photolithography and wet etching are carried out so as to pattern the metal film. Through these steps, the signal line 24 is formed on the organic insulating film 104, at a position that overlaps with the data line 22 when viewed in a plan view (see FIG. 12A).

Next, a transparent electrode film made of, for example, ITO is formed on the organic insulating film 104, and photolithography and wet etching are carried out so as to pattern the transparent electrode film. Through these steps, the counter electrode 23 is formed on the organic insulating film 104 at a position that does not overlap with the signal line 24 (see FIG. 12B).

Subsequently, the inorganic insulating film 105 made of, for example, silicon nitride (SiNₓ) is formed on the organic insulating film 104 so as to cover the signal line 24 and the counter electrode 23 (see FIG. 120).

Then, a transparent electrode film made of, for example, ITO is formed on the inorganic insulating film 105, and then, photolithography and wet etching are carried out so as to pattern the transparent electrode film. Through these steps, the pixel electrode 251 is formed at a position that overlaps with the counter electrode 23 (see FIG. 12D).

Next, the inorganic insulating film 116 made of, for example, silicon nitride (SiNₓ) is formed on the inorganic insulating film 105 so as to cover the pixel electrode 251 (see FIG. 12E).

Subsequently, a transparent electrode film made of, for example, ITO is formed on the inorganic insulating film 116, and then, photolithography and wet etching are carried out so as to pattern the transparent electrode film. Through these steps, the common electrode 231 is formed on the inorganic insulating film 116 at a position that does not overlap with the pixel electrode 251 (see FIG. 12F).

The foregoing description describes examples of the touch-panel-equipped display device according to the present invention, but the configuration of the touch-panel-equipped display device according to the present invention is not limited to the configurations of the above-described embodiments, but may have any one of a variety of modified configurations. The following description describes the modification examples.

### Modification Example 1

In the above-described embodiments, the semiconductor film 70b is not limited to the oxide semiconductor film, but may be an amorphous silicon film.

### Modification Example 2

The foregoing embodiments are described with reference to an example in which the touch-panel-equipped display device includes an active matrix substrate, a counter substrate, a liquid crystal layer, polarizing plates, and a backlight, but the touch-panel-equipped display device may include at least an active matrix substrate, a counter substrate, and a liquid crystal layer.

### Modification Example 3

The foregoing embodiments are described with reference to an example in which the TFT has such a top gate structure that the gate electrode 70a is arranged on the liquid crystal layer 3 side with respect to the semiconductor film 70b; the TFT, however, may have such a bottom gate structure that the gate electrode 70a is provided on the glass substrate 100 side with respect to the semiconductor film 70b.

### Modification Example 4

The foregoing embodiments are described with reference to an example in which the data lines 22 are arranged in such a manner that each of the same is arranged between adjacent ones of the counter electrodes 23 that are adjacent in the gate line 21 extending direction. The configuration, however, may be such that each gate line 21 is arranged between the counter electrodes 23 adjacent in the data line 22 extending direction. Or alternatively, the configuration may be such that at least one data line 22 is arranged between adjacent ones of the counter electrodes 23 that are adjacent in the gate line 21 extending direction, and additionally, at least one gate line 21 is arranged between adjacent ones of the counter electrodes 23 that are adjacent in the data line 22 extending direction.

1. A touch-panel-equipped display device having an active matrix substrate, a counter substrate provided so as to be opposed to the active matrix substrate, and a liquid crystal layer provided between the active matrix substrate and the counter substrate, and having a touch surface on an active matrix substrate side,
the active matrix substrate includes:
a substrate; and
a plurality of pixel electrodes, a plurality of counter electrodes to detect a touch with respect to the touch surface and make capacitances between the same and the pixel electrodes, and a plurality of signal lines connected with the counter electrodes, on a liquid crystal layer side of the substrate,
the counter substrate includes, on a surface thereof on a side opposite to the liquid crystal layer side, shield electrodes that are arranged so as to overlap with the counter electrodes when viewed in a plan view and have a reference potential,
wherein the pixel electrodes and the counter electrodes are arranged so as to overlap with each other when viewed in a plan view, and the counter electrodes are arranged at positions closer to the substrate than the pixel electrodes are.

2. The touch-panel-equipped display device according to claim 1,
wherein the active matrix substrate further includes a plurality of gate lines, and a plurality of data lines that intersect with the gate lines, on the liquid crystal layer side of the substrate,
the counter electrodes are arranged so as to be arrayed in a gate line extending direction and a data line extending direction, and
at least one data line is arranged between adjacent ones of the counter electrodes that are adjacent in the gate line extending direction when viewed in a plan view.

3. The touch-panel-equipped display device according to claim 1,
wherein the active matrix substrate further includes a plurality of gate lines, and a plurality of data lines that intersect with the gate lines, on the liquid crystal layer side of the substrate,
the counter electrodes are arranged so as to be arrayed in a gate line extending direction and a data line extending direction, and
at least one gate line is arranged between adjacent ones of the counter electrodes that are adjacent in the data line extending direction when viewed in a plan view.

4. The touch-panel-equipped display device according to claim 1,
wherein the signal lines and the pixel electrodes are arranged in different layers.

5. The touch-panel-equipped display device according to claim 1,
wherein the active matrix substrate further includes:
a first insulating film that is arranged between the counter electrodes and the pixel electrodes;
a second insulating film that is arranged on a side opposite to the counter electrodes with respect to the pixel electrodes, and covers the pixel electrodes; and
a transparent electrode that is arranged so as to overlap with the pixel electrodes with the second insulating film being interposed therebetween, and is electrically connected with the counter electrodes.

6. The touch-panel-equipped display device according to claim 1,
wherein the active matrix substrate further includes a plurality of switching elements each of which includes a source electrode, a drain electrode, a semiconductor film, and a gate electrode, and
the gate electrode is provided on the liquid crystal layer side with respect to the semiconductor film.

7. The touch-panel-equipped display device according to claim 1,
wherein the active matrix substrate further includes a plurality of switching elements each of which includes a source electrode, a drain electrode, a semiconductor film, and a gate electrode, and
the gate electrode is provided on the substrate side with respect to the semiconductor film.

8. The touch-panel-equipped display device according to claim 1,
wherein the active matrix substrate further includes a light-shielding section between the pixel electrodes and the substrate.

9. The touch-panel-equipped display device according to claim 8,
wherein the light-shielding section is arranged at a position that does not overlap with the pixel electrodes.
